(19) United States
(12) Patent Application Publication
(10) Pub. No.: US 2016/0292431 A1
(43) Pub. Date: Oct. 6, 2016

(54) MANAGEMENT OF ENCRYPTION KEYS IN AN APPLICATION CONTAINER ENVIRONMENT

(71) Applicant: defend7, Inc., Mountain View, CA (US)

(72) Inventors: Vibhav Sreekanti, Pleasanton, CA (US); Gaurav Mathur, Palo Alto, CA (US); Richard Spillane, Mountain View, CA (US); Gordon Chaffee, Hillsborough, CA (US)

(21) Appl. No.: 14/677,566

(22) Filed: Apr. 2, 2015

(51) Int. Cl. G06F 21/60; H04L 9/14

(52) U.S. Cl. CPC G06F 21/602; H04L 9/14; H04L 2209/24

(57) ABSTRACT

Systems, methods, and software to manage encryption keys in an application container environment are provided. In one example, a method of managing encryption keys comprises identifying a plurality of data objects to encrypt and encrypting the plurality of data objects via a plurality of encryption keys. The method further provides generating supplemental data for each data object, wherein the supplemental data for each data object comprises a key identifier that corresponds to an encryption key used to encrypt each data object. The method further includes associating the supplemental data for each data object with the encrypted version of each data object, and organizing the key identifiers from the plurality of data objects into a data structure with the plurality of encryption keys.

### TECHNICAL FIELD

Aspects of the disclosure are related to computing security and in particular to managing encryption keys to secure application containers.

### TECHNICAL BACKGROUND

An increasing number of data security threats exist in the modern computerized society. These threats may include viruses or other malware that attacks the local computer of the end user, or sophisticated cyber attacks to gather data and other information from the cloud or server based infrastructure. This server based infrastructure includes physical and virtual computing devices that are used to provide a variety of services to user computing systems, such as data storage, cloud processing, web sites and services, amongst other possible services. To protect applications and services, various antivirus, encryption, and firewall implementations may be used across an array of operating systems, such as Linux and Microsoft Windows.

A firewall is a software or hardware-based network security system that controls the incoming and outgoing network traffic based on applied rule set. For example, a firewall may be implemented in a computing system to prevent incoming connections from possibly harmful computing systems. Further, encryption is the process of encoding messages or information in such a way that only authorized parties may read or understand the saved material. Thus, if users attempt to store sensitive information, such as social security information, encryption may be used as a failsafe to prevent unwanted parties from understanding the information even if the stored data is accessible.

In addition to the protective measures discussed above, segregation methods have also been pursued to limit the interaction between systems and applications. These segregation methods include whole system virtualization, which includes a full operating system and one or more applications, as well as application containers that are used to reduce dependencies on other cooperating applications. However, separating the applications into different virtual machines or application containers can add complexity to the security configurations for each of the executing applications.

### Overview

Provided herein are systems, methods, and software to manage encryption keys in an application container environment. In one example, a method of managing encryption keys includes, in one or more processing systems, identifying a plurality of data objects to encrypt for a plurality of application containers, and encrypting the plurality of data objects via a plurality of encryption keys. The method further includes generating supplemental data for each data object in the plurality of data objects, wherein the supplemental data for each data object in the plurality of data objects comprises a key identifier corresponding to an encryption key of the plurality of encryption keys used to encrypt each data object in the plurality of data objects. The method also provides associating the supplemental data for each data object with the encrypted version of each data object in the plurality of data objects, and organizing key identifiers from the plurality of data objects into a data structure with the plurality of encryption keys.

In another instance, a computer apparatus to manage encryption keys for a plurality of application containers includes processing instructions that direct a computing system to identify a plurality of data objects to encrypt for the plurality of application containers, and encrypt the plurality of data objects via a plurality of encryption keys. The processing instructions further direct the computing system to generate supplemental data for each data object in the plurality of data objects, wherein the supplemental data for each data object in the plurality of data objects comprises a key identifier corresponding to an encryption key of the plurality of encryption keys used to encrypt each data object in the plurality of data objects. The processing instructions also direct the computing system to associate the supplemental data for each data object with the encrypted version of each data object in the plurality of data objects, and organize key identifiers from the plurality of data objects in a data structure with the plurality of encryption keys. The computer apparatus also comprises one or more non-transitory computer readable media that store the processing instructions.

In a further example, a computer apparatus to manage encryption keys in an application container environment includes processing instructions that direct a computing system to identify a data object in a first application container for encryption, and generate an encrypted version of the data object via an encryption key. The processing instructions further direct the computing system to associate a key identifier with the encrypted version of the data object, wherein the key identifier corresponds to the encryption key. The processing instructions also direct the computing system to store the key identifier and the encryption key within a data structure, and identify the encrypted version of the data object in a second application container. The processing instructions additionally direct the computing system to identify the encryption key for decryption based on the key identifier associated with the encrypted version of the data object and the data structure, and decrypt the encrypted version of the data object via the encryption key. The computer apparatus further includes one or more non-transitory computer readable media that store the processing instructions.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to manage encryption keys for data objects.

FIG. 2 illustrates a method of managing encryption keys for data objects in an application container environment.

FIG. 3 illustrates an overview of managing encryption keys for data objects.

FIG. 4 illustrates a data structure for managing encryption keys in an application container environment.

FIG. 5 illustrates an overview of encrypting data objects in an application container environment.

FIG. 6 illustrates an overview of decrypting data objects in a computing environment.

FIG. 7 illustrates a system to manage encryption keys with a plurality of application containers.

FIG. 8 illustrates a flow diagram to use expiring encryption keys to encrypt data objects within an application container environment.

FIG. 9 illustrates an overview of encrypting and decrypting data objects within an application container environment.

FIG. 10 illustrates a computing system to encrypt and decrypt data objects in an application container environment.

### TECHNICAL DISCLOSURE

Internet services rely extensively on security to prevent unpermitted processes and users from accessing sensitive data. Such data may include usernames, passwords, social security numbers, credit card numbers, amongst other sensitive data. To prevent the unpermitted access, firewalls, antiviruses, and other security processes may be executed on the devices hosting the internet services. These security processes are designed to prevent improper access, or mitigate the effects once a breach has occurred.

In some examples, multiple applications may be necessary to provide specific services to end user devices, such as front-end applications, back-end applications, data service applications, or any other applications. Each of these applications are responsible for a particular task, such as taking in and storing data, processing data that is received, organizing data received, or any other task necessary for the service. These applications may be implemented on one or more computing devices and processing systems configured by an administrator to perform the associated service.

In the present example, application containers are provided to segregate and help secure data as it is used within a computing environment. These application containers, which operate on one or more host systems, can package an application and its dependencies in a virtual container, and run the containerized applications as an isolated process on the host operating systems. These containers may include Linux containers, jails, partitions, or other types of containment modules, and may also include virtual machines in some examples. Accordingly, because the application does not contain dependencies from other applications, the application is essentially segregated from other applications and processes executing on the same host computing system.

Here, in addition to the application, the container also includes a security layer to act as a transparent intermediary between the application, and other processes or systems external to the application container. This security layer may include encryption, firewall, storage interface, and communication interface modules that can be configured based on the application for the container. For example, a front-end application that places data within a storage volume may not require access to sensitive data values, such as social security numbers and credit card numbers. Accordingly, rather than permitting the application to read the received sensitive data, the security layer may transparently encrypt the received data before passing the data to the application.

To manage the encryption and security keys for the application containers, a key management service is provided. The key management service may be used to manage the various keys that are used to encrypt data objects as they are received or transferred from an application container. These data objects may include, user profile information, social security information, credit card information, files, and documents, amongst a variety of other data objects. For example, as an application container receives a data object, the security layer for the application may be used to encrypt the data object using one of a plurality of keys. To identify which of the keys belong to the data object, supplemental data may be generated that includes a key identifier corresponding to the encryption key used in encrypting the file. This supplemental data may then be inserted within the encrypted version of the data object to allow a container to decrypt the data by identifying the proper key used in the objects encryption.

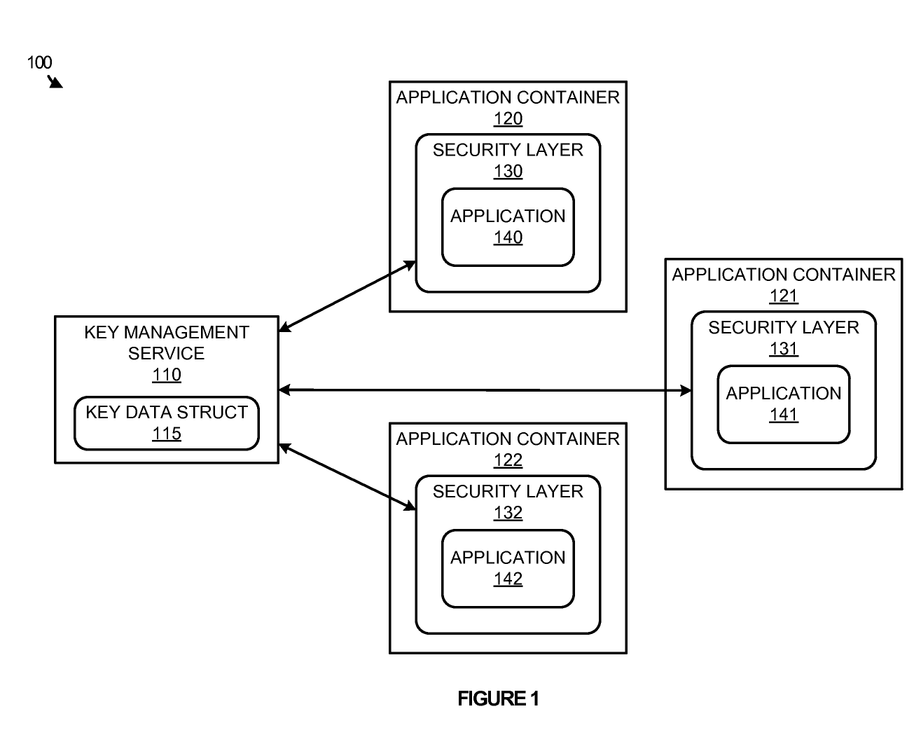

To further demonstrate the encryption of data objects in a containerized environment, FIG. 1 is provided. FIG. 1 illustrates a computing environment 100 to manage encryption keys for data objects. Computing environment 100 includes key management service 110 and application containers 120-122. Key management service 110 further includes key data structure 115, and application containers 120-122 further include security layers 130-132 and applications 140-142. Each of application containers 120-122 may comprise a Linux container, jail, partition, or other type of containment module, and may also comprise a full operating system virtual machine in some examples.

In operation, applications 140-142 may be used to provide different functionality within computing environment 100. For example, application container 120 may provide front end server functionality, whereas application containers 121-122 may provide the back end functionality. To maintain security for each of the applications within the environment, security layers 130-132 are provided. Each security layer of security layers 130-132 is configured to act as a secure and transparent intermediary between the application in the containers and at least one process or system external to the application container. Security layers 130-132 may include a variety of security modules including encryption, firewall, storage interface, and communication interface modules.

Here, security layers 130-132 may be used to encrypt and decrypt data as it is sent and received by application containers 120-122. To manage the keys for encryption, key management service 110 is provided. Key management service 110 allows one application within a first application container to encrypt data, and allow a second application container with a second application to decrypt the data. For example, as application container 120 receives data, security layer 130 may be used to assist in encrypting the various data objects. Once processed by application 140, the encrypted version of the data objects may be transferred to application container 121, wherein security layer 131 may be used to decrypt the data objects.

To identify the proper encryption key for an encrypted data object, supplemental data may be added to each data object as it is encrypted. This supplemental data comprises an identifier than can be used to identify the appropriate key needed to decrypt a data object. Thus, when a data object requires decrypting, a security layer may contact key management service 110 to identify the appropriate key required for decryption.

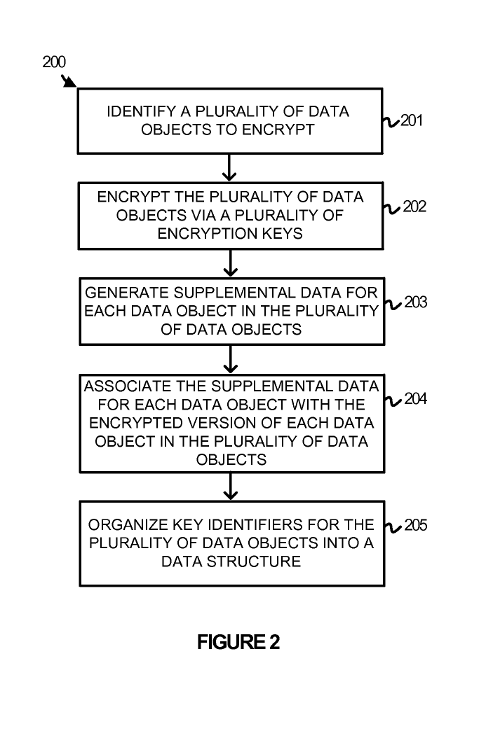

Referring to FIG. 2, FIG. 2 illustrates a method 200 of managing encryption keys for data objects in an application container environment. The method includes identifying a plurality of data objects to encrypt for a plurality of application containers (201), and encrypting the plurality of data objects via a plurality of encryption keys (202). The method further includes generating supplemental data for each data object in the plurality of data objects (203), wherein the supplemental data comprises a key identifier corresponding to an encryption key of the plurality of encryption keys used to encrypt each data object. The method also includes associating the supplemental data with the encrypted versions of the plurality of data objects (204), and organizing the key identifiers and the encryption keys into a data structure (205).

Turning to FIG. 1 as an example, application containers 120-122 may require the encryption of a plurality of data items using security layer 130. In some instances, the encryption of the data may occur within security layers 130-132, but may also occur externally in key management service 110 or some other encryption system. Once the data objects are identified for encryption, the data objects are encrypted and assessed supplemental data to identify the key used in encryption.

As illustrated in computing system 100, each of security layers 130-132 may communicate with key management service 110. Accordingly, when a data object is encrypted, an identifier is generated that corresponds to the key that was used to encrypt the data. This identifier is then stored in key data structure 115 with the key that was used to encrypt the data. Once the encryption keys and identifiers are stored in key data structure 115, key data structure 115 may be used to assist in the decryption of data objects when necessary. For example, a data object may be transferred to application container 120 and encrypted using security layer 130 before being processed by application 140. Once processed, the encrypted data object may be transferred to application container 121, and decrypted using security layer 131. To decrypt the data, security layer 131 may transfer the supplemental data, the identifier, or the entire data object to key management service 110 to determine the proper encryption key to use in the decryption.

In some examples, each encryption key may only be used for a predefined period of time. Accordingly, first data objects may be encrypted using a first key for a first period of time, and second data objects may be encrypted using a second key for a second period of time. Further, because data objects may be encrypted at a first application container but require decryption at a second container, key management service 110 may be used to manage the keys used by all application containers. This would allow any data object encrypted at a first container to be decrypted at an alternative container.

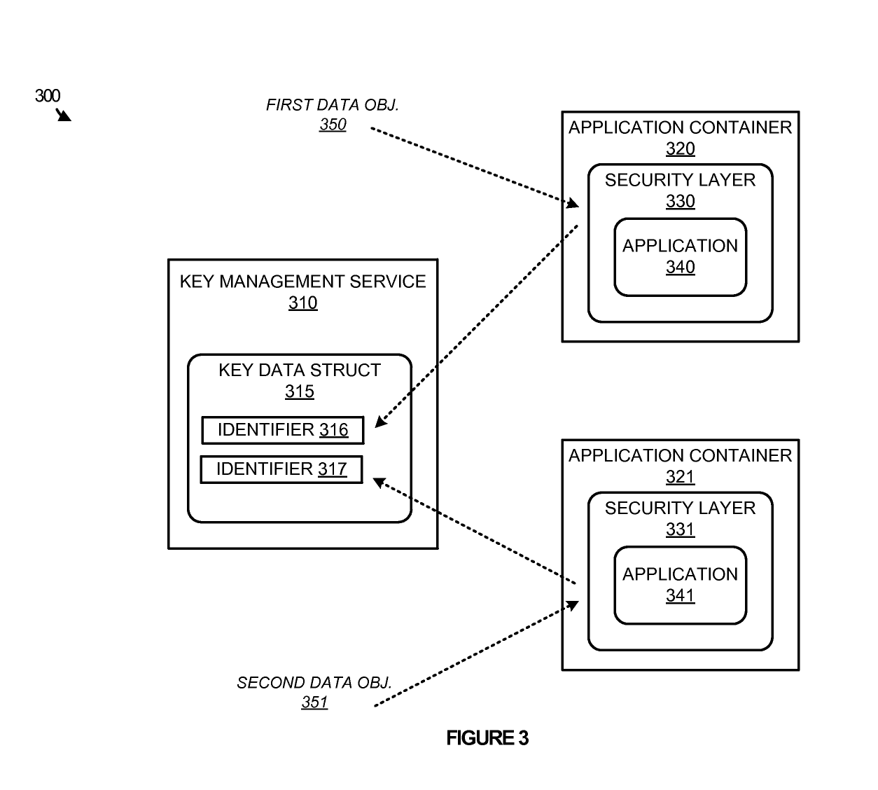

Referring now to FIG. 3, FIG. 3 illustrates an overview 300 of managing encryption keys for data objects in an application container environment. Overview 300 includes key management service 310 and application containers 320-321. Key management service 310 further includes key data structure 315, and application containers 320-321 further include security layers 330-331 and applications 340-341. Security layers 330-331 are configured to act as encryption intermediaries between applications 340-341, and processes and systems external to the respective application containers. These processes and systems may include other application containers, data storage systems, other computing devices, amongst a variety of other processes and systems.

As illustrated in FIG. 3, data objects 350-351 are transferred to application containers 320-321. These data objects may include social security information, credit card information, user profile information, documents, pictures, or any other similar data object. As each of the data objects are received, security layers 330-331 are configured to initiate the encryption of the data objects. This encryption may occur internally within security layers 330-331, may occur externally in key management service 310, or may occur at any other system configured to encrypt data objects for applications within the application containers. As data objects 350-351 are encrypted, supplemental data is generated that includes an identifier corresponding to the encryption key used to encrypt each data object. Accordingly, once the object is encrypted, the supplemental data for the object may be associated with the object to determine which key was used in the encryption.

In addition to associating the supplemental data with the data object, key identifiers 316-317 are stored within key data structure 315 to maintain a record of the various encryption keys used to encrypt the data objects. As a result, when a security layer within an application container environment requires the decryption of a specific data object, the security layer may transfer the supplemental data, the identifier, or the entire data object to key management service 310 to determine the proper encryption key required for the decryption.

In some examples, the encryption keys used for the application containers consistently change to prevent improper access to the encrypted data. These different encryption keys may be assessed on a per application container basis, assessed for time period for certain time periods, or any other method of consistently modifying the encryption keys, including combinations thereof. As the keys change, it is necessary to maintain a record of the keys that were used to encrypt each data object. Thus, even if the data object is transferred to a different application container, or the same container using a different key, key data structure 315 may be used to identify the proper encryption key.

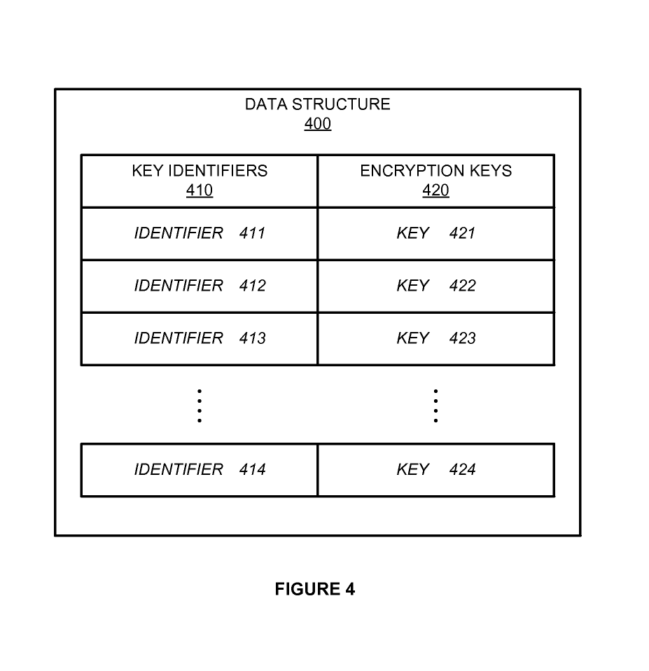

Turning to FIG. 4, FIG. 4 illustrates a data structure 400 for managing encryption keys in a containerized computing environment. Data structure 400 includes key identifiers 410 and encryption keys 420. Data structure 400 is an example of key data structure 115 and key data structure 315, although other examples may exist. Although illustrated as a table in the present example, it should be understood that data structure 400 might comprise an array, a list, or any other similar data structure to store key identifiers and encryption keys.

In operation, application containers within a computing environment may include security layers that encrypt data objects transparently without modifying the application within the container. As data objects are encrypted, key identifiers are associated with each of the encrypted data objects to ensure that the encryption key may later be retrieved to decrypt the object. Accordingly, in addition to associating the key identifier with the object, data structure 400 is maintained within a key management system to ensure that a record is maintained of the various keys to encrypt the data objects.

For example, a first container may use identifier 411 to encrypt data objects, whereas a second container may use identifier 412 to encrypt second data objects. When it is required to decrypt the data objects, a security layer within the application container or some other system within the application container environment may contact the key management system to determine the necessary encryption key to decrypt the data object. By maintaining a data structure for all encryption keys within the application container environment, each application container within the environment may decrypt a data object even if the container did not encrypt the particular object.

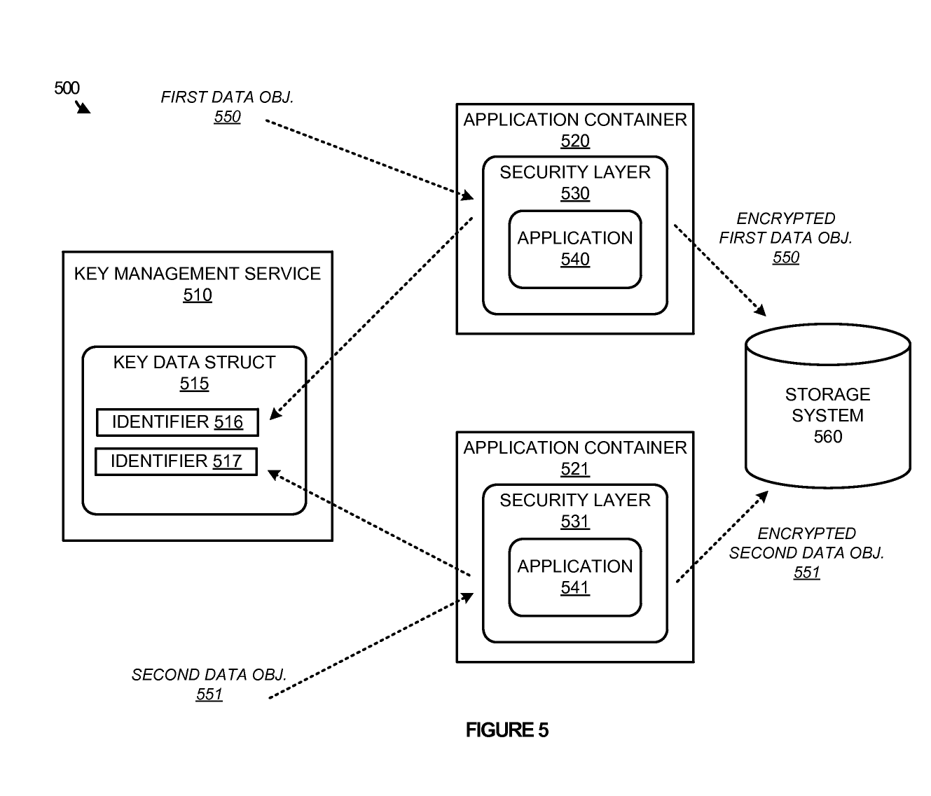

FIG. 5 illustrates an overview 500 of encrypting data objects in a computing environment. Overview 500 includes key management service 510, application containers 520-521, and storage system 560. Key management service 510 further includes key data structure 515 that is used to store key identifiers for one or more data objects. Application containers 520-521 further include security layers 530-531 that are used to act as a communication intermediary between applications 540-541, and systems or processes external to application containers 520-521.

In operation, application containers 520-521 may receive various data objects from other applications, computing systems, storage systems, and any other similar process or system. As the objects are received, the objects may be encrypted using security layers 530-531. In the present example, application containers 520-521 receive data objects 550-551, respectively. Responsive to receiving data objects 550-551, security layers 530-531 may initiate encryption of the data prior to storing the encrypted data objects in storage system 560. In some examples, the encryption may occur before allowing the object to be processed by applications 540-541. However, in other instances, encryption of the data objects may occur after they are processed by the applications.

While the data objects are being encrypted, either within security layers 530-531 or in a separate encryption system, supplemental data with key identifiers are generated to determine which key was used in the objects encryption. This supplemental data is then associated with each encrypted data object, or placed inside the encrypted data object, as an identifier for the encryption key. Similarly, the key identifiers are also maintained with key data structure 515, which associates the identifier to the appropriate key. For example, as first data object 550 is encrypted, supplemental data is associated with the encrypted object, wherein the supplemental data includes identifier 516 for the key used in the encryption. Similarly, identifier 516 is also organized within data structure 515 that associates identifier 516 to the key that was used in the encryption. Accordingly, any container that is approved to decrypt the data object may use key data structure 515 to identify the appropriate key necessary for the decryption.

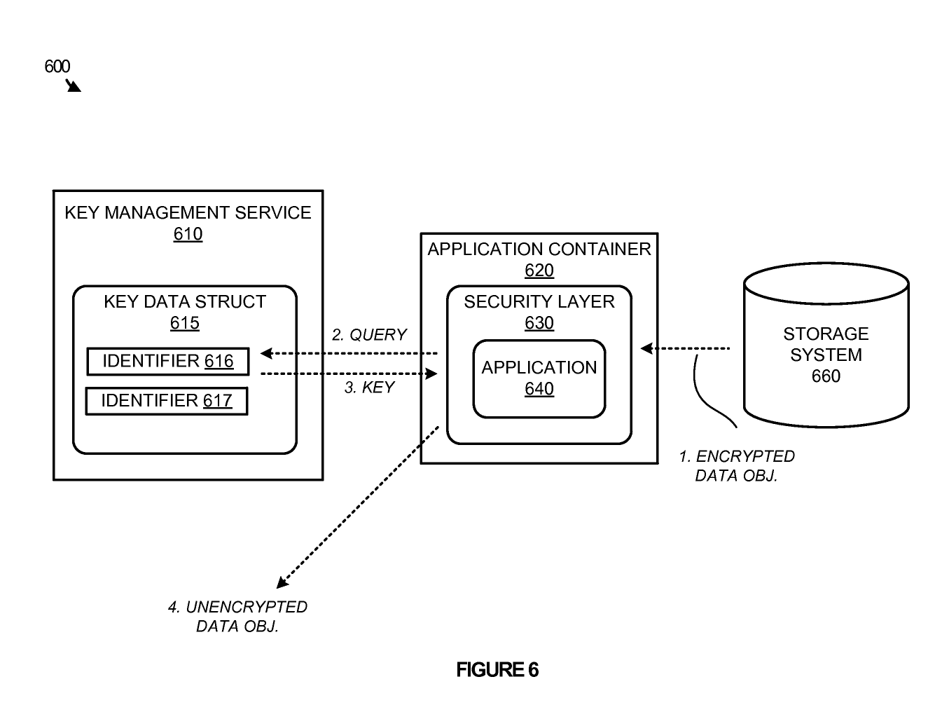

As a further illustration of the decryption process, FIG. 6 is provided. FIG. 6 includes key management service 610, application container 620, and storage system 660. Key management service 610 further includes key data structure 615 that is used to store key identifiers for one or more data objects. Application container 620 further include security layer 630 that is used to act as a communication intermediary between application 640, and one or more processes or systems external to application container 640.

As depicted, encrypted data objects are stored within storage system 660. Storage system 660 may comprise a physical storage device, a virtual storage device, a network attached storage device, or any other storage system external to application container 620. During the execution of application 640 a call may be made to retrieve an encrypted data object from storage system 600. Once retrieved, and either before or after processing by application 640, the data object may require decryption. To accomplish this task, security layer 630 contacts key data structure 615 in key management service 610 to determine the proper encryption key to decrypt the object. Here, associated with the encrypted data object is supplemental data that comprises at least key identifier 616. Key identifier 616 corresponds to a key that can be used in the decryption of the data object retrieved from storage system 660. Accordingly, once the key is retrieved, the object may be decrypted and transferred to another process or system. These processes and systems may include other application containers, other applications, other computing systems, other storage systems, or any other similar process or system.

Although illustrated in the present example as being decrypted within security layer 630, it should be understood that the decryption processes might occur in another module external to application container 620. For instance, security layer 630 may offload the decryption and encryption processes to key management service 610. Thus, rather than decrypting the object locally, security layer may forward the entire object to key management service 610 for decryption prior to transferring the object to next system or process.

Further, although not illustrated in the present instance, it should be understood that data objects might be encrypted and stored in storage system 660 using one application container, but decrypted and processed by a second application container. Accordingly, key data structure 615 allows multiple application containers to share keys and provide encryption processes within an application container environment.

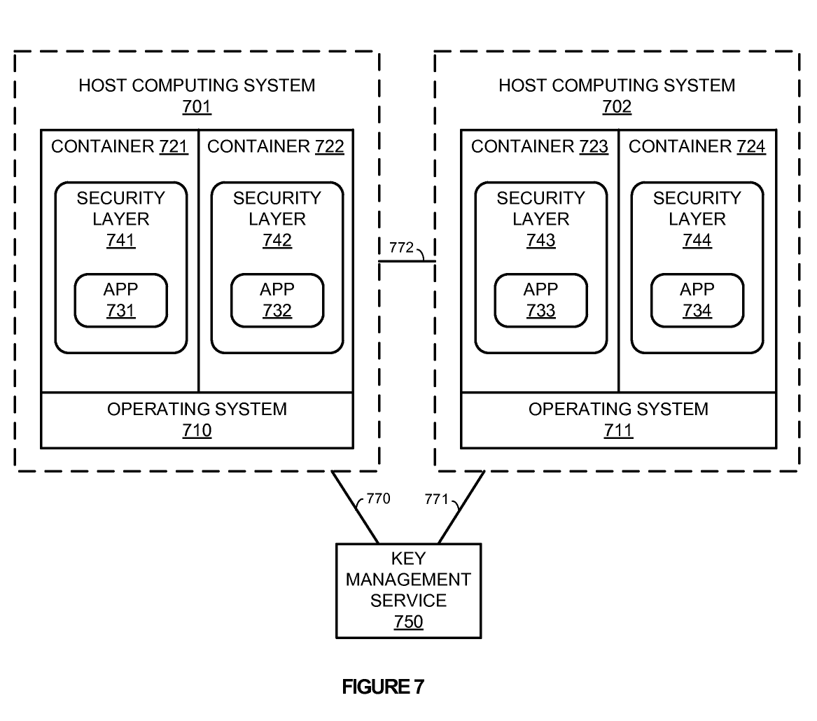

FIG. 7 illustrates a system 700 for managing encryption keys with a plurality of application containers. System 700 includes host computing systems 701-702 and key management service 750. Host computing systems 701-702 further include operating systems 710-711 and application containers 721-724. Host computing systems 701-702 communicate with key management service 750 over communication links 770-771. Host computing system 701 communicates with host computing system 702 over communication link 772.

Host computing systems 701-702 and key management service 750 may each comprise a router, server, memory device, software, processing systems or circuitry, cabling, power supply, network communication interface, structural support, or some other communication or computer apparatus. In some examples, host computing systems 701-702 and key management service 750 may each comprise one or more server computers, desktop computers, laptop computers, or other similar computing devices. Although illustrated as a separate computing device, it should be understood that key management service 750 might be implemented wholly or partially within host computing systems 701-702.

Communication links 770-772 each use metal, glass, optical, air, space, or some other material as the transport media. Communication links 770-772 may use Time Division Multiplex (TDM), asynchronous transfer mode (ATM), IP, Ethernet, synchronous optical networking (SONET), hybrid fiber-coax (HFC), circuit-switched, communication signaling, wireless communications, or some other communication format, including improvements thereof. Communication links 770-772 may each be a direct link, or may include intermediate networks, systems, or devices, and may include a logical network link transported over multiple physical links.

In operation, application containers 721-724 are initiated on host computing systems 701-702. Application containers 721-724 package an application and its dependencies in a virtual package, and run the containerized applications as an isolated process in userspace on the host system. Application containers 731-734 may include Linux containers, jails, partitions, or other types of containment modules, and may also include full operating system virtual machines in some examples. In the present instance, in addition to applications 731-734, each of the containers further includes a security layer that is used as an intermediary between the application within the container, and processes systems external to the container. Thus, the security layer may include firewall, encryption, and communication interface modules that are used to insulate the application from inappropriate communications.

Here, security layers 741-744 are configured to transparently encrypt or decrypt data objects as they are transferred or received for applications 731-734. As the data objects are encrypted, supplemental data may be generated that includes an identifier for the encryption key that was used in encrypting the data object. These identifiers and the associated keys may then be stored within a data structure that allows future decryption of the data object using any of the approved security layers. To manage the data structure, key management service 750 is provided. Key management service 750 may communicate with any of the application containers to store the key identifiers and encryption keys for later retrieval by any of the application containers.

For example, security layer 741 within application container 721 may encrypt a first data object before transferring the data object to application container 722. As the object is encrypted, a key identifier is associated or placed within the encrypted version of the data object. Correspondingly, a data structure within key management service 750 maintains a record of the key identifier and associates the key identifier to the encryption key used for the particular object. Thus, if application container 722 requires the unencrypted version of the data object, security layer 742 may use the key identifier and the database to identify the proper key to be used for decryption.

Although illustrated as encrypting and decrypting the data objects locally within containers 721-724, it should be understood that encryption and decryption might occur externally of the application containers in some examples. For instance, containers 721-724 may rely on key management service 750 to encrypt the data or some other encryption computing system.

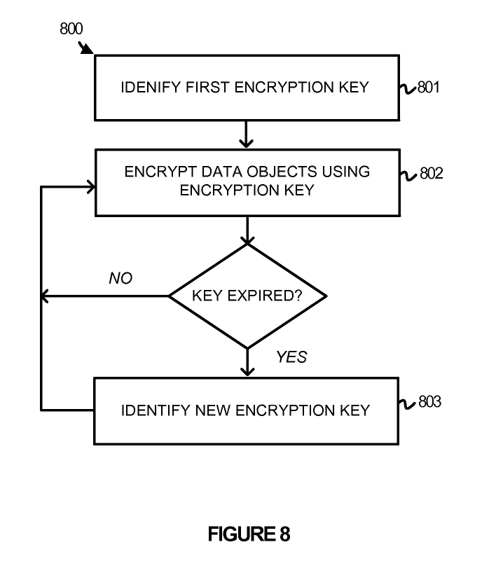

FIG. 8 illustrates a flow diagram 800 for using expiring encryption keys to encrypt data objects within an application container environment. As illustrated, a first encryption key is identified for encryption (801). In some examples, each application container within the application container environment is given a unique encryption key. Accordingly, if a service required the use of a plurality of application containers, each container may encrypt data using distinct encryption keys from the other containers. In other instances, one or more of the containers within the environment may share encryption keys, allowing each of the containers to encrypt data objects using the same key. Once a key is identified, data objects are encrypted using the identified key (802).

Here, because the keys may be consistently changed, a key identifier is associated with each of the encrypted data objects. This key identifier is also stored within a data structure that allows the recalling of the encryption key to decrypt the data object. Thus, even if the data object is encrypted for a first application container, a second approved application container may recall the encryption key to decrypt the data object. As further illustrated in FIG. 8, during the encryption process the key is consistently monitored to determine if the key has expired. This expiration may occur every minute, hour, day, or any other period of time. If the key is not expired, data objects will continue to be encrypted using the current encryption key (803). However, if the encryption key is expired, a new encryption key is identified (803) before returning to encrypt further data objects.

In some examples, the encryption keys are provided by a key management service for the entire environment. Accordingly, each application container may be communicatively coupled to the key management service to allow the service to provide encryption keys, manage the database of used encryption keys, or any other similar encryption task.

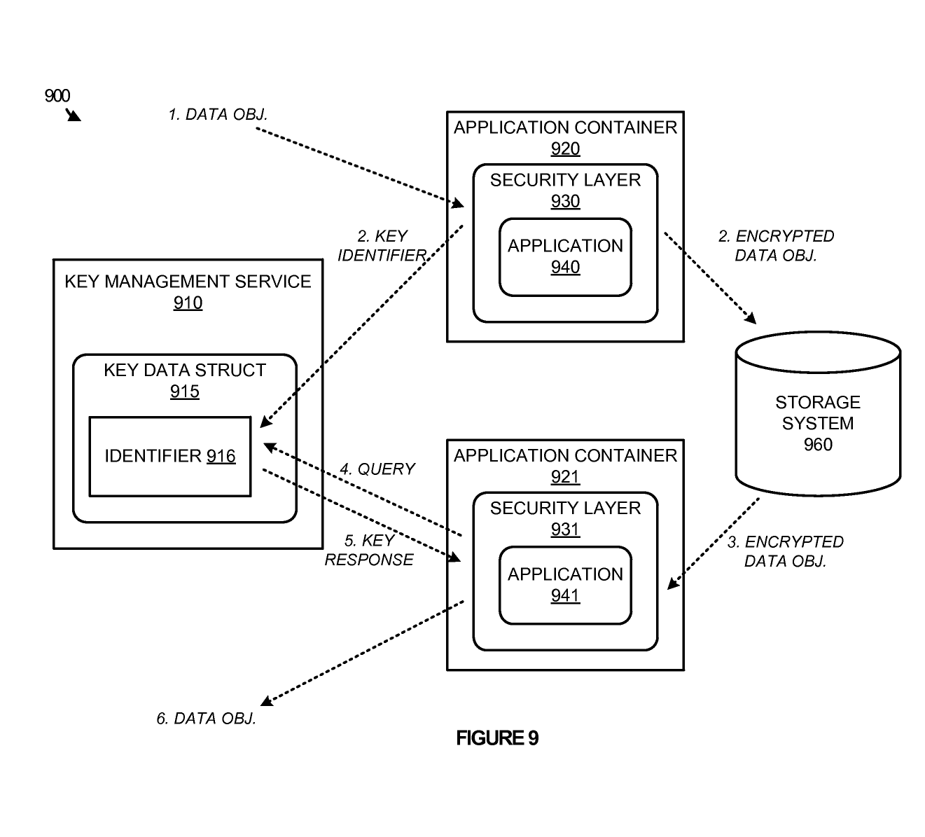

FIG. 9 illustrates an overview 900 of encrypting and decrypting data objects within an application container environment. Overview 900 includes key management service 910, application container 920-921, and storage system 960. Key management service 910 further includes key data structure 915. Application containers 920-921 further include security layers 930-931 and applications 940-941.

In operation, security layer 930 receives a data object. This data object may be received from another application, another computing system, a storage system, or some other similar process or system. Before or after the data object is processed by application 940, the data object is encrypted using at least security layer 930. To encrypt the data object, an encryption key is used that is also associated with an identifier 916. Accordingly, as the object is encrypted, identifier 916 is associated with the data object and, in some examples, placed within supplemental data for the data object. Additionally, identifier 916 is stored within key data structure 915 with the associated encryption key. By storing identifier 916 in key data structure 915, various application containers may have access to the key to decrypt the data object when necessary.

As illustrated in FIG. 9, once the data object is encrypted and processed by application 940, the data object is stored within storage system 960. From storage system 960, the object is retrieved for application container 921. Before or after the data object is processed by application 941, the data object is decrypted based on key data structure 915. For example, security layer 931 may retrieve the key identifier that is associated or stored with the data object. Once identified, a query is transferred to key management service 910 to determine the proper encryption key required to decrypt the data object. Based on the encryption key stored with identifier 916 in key data structure 915, the security layer may decrypt the data object, returning the data object to the original state.

Although illustrated in the present example as decrypting the data object locally within application container 921, it should be understood that the decryption of the data object might occur in key management service 910 or some other encryption system communicatively coupled to application container 921. Similarly, although the encryption of the data object is illustrated as occurring locally within application container 920, it should be understood that the encryption process might be offloaded to key management service 910 or some other encryption system communicatively coupled to application container 910.

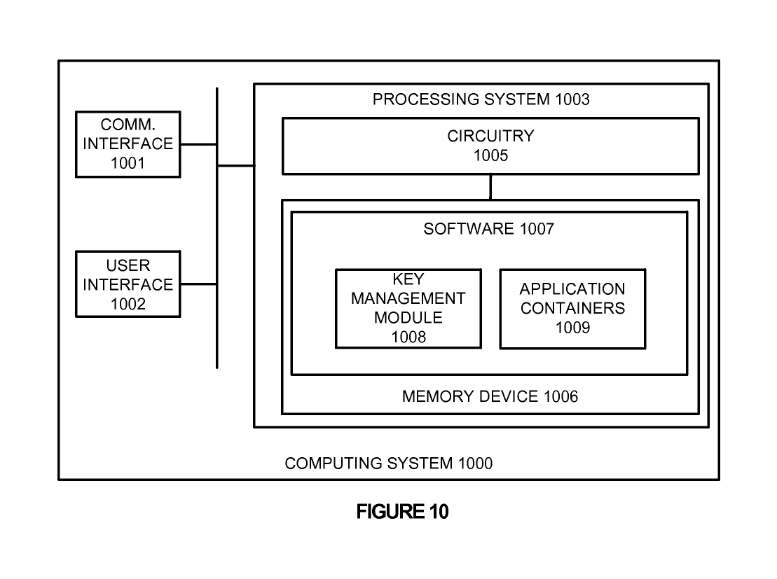

FIG. 10 illustrates a computing system 1000 to provide encryption key management for secure application containers. Computing system 1000 is representative of a computing system that may be employed in any computing apparatus, system, or device, or collections thereof, to suitably implement computing environment 100 or the other application container environments described herein. Computing system 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007.

Communication interface 1001 comprises components that communicate over communication links, such as network cards, ports, radio frequency (RF) transceivers, processing circuitry and software, or some other communication devices. Communication interface 1001 may be configured to communicate over metallic, wireless, or optical links. Communication interface 1001 may be configured to use TDM, Internet Protocol (IP), Ethernet, optical networking, wireless protocols, communication signaling, or some other communication format—including combinations thereof.

User interface 1002 comprises components that interact with a user. User interface 1002 may include a keyboard, display screen, mouse, touch pad, or some other user input/output apparatus. User interface 1002 may be omitted in some examples.

Processing circuitry 1005 comprises microprocessor and other circuitry that retrieves and executes operating software 1007 from memory device 1006. Memory device 1006 comprises a non-transitory storage medium, such as a disk drive, flash drive, data storage circuitry, or some other memory apparatus. Operating software 1007 comprises computer programs, firmware, or some other form of machine-readable processing instructions. Operating software 1007 includes key management module 1008 and application containers 1009, although any number of software modules may provide the same functionality. Operating software 1007 may further include operating systems, utilities, drivers, network interfaces, applications, or some other type of software. When executed by circuitry 1005, operating software 1007 directs processing system 1003 to operate computing system 1000 as described herein.

In particular, computing system 1000 is configured to provide a platform for application containers 1009. Application containers 1009 may include Linux containers, jails, partitions, or other types of containment modules, and may also include virtual machines in some examples. Within each of application containers 1009 is at least one unmodified application and a security layer configured to transparently manage interactions between the at least one application, and systems or processes external to the application container.

In the present example, the security layer is configured with at least one encryption module configured to encrypt and decrypt data as it is received or transferred from the application container. To manage the encryption keys necessary for this service, key management module 1008 is provided. Key management module 1008 is configured to manage a data structure of one or more key identifiers that are associated with encryption keys that are used to encrypt various data objects.

For example, application containers 1009 may initiate encryption of a plurality of data objects using a plurality of encryption keys. During the encryption process, a key identifier is associated with or placed within the encrypted version of the data objects. Similarly a data structure is constructed using key management module 1008 that associates the key identifiers with the encryption keys used to encrypt the data objects. Accordingly, when it is necessary to decrypt a data object, a request may be transferred to key management module 1008 to determine the appropriate encryption key for the decrypting process. In some examples, the request to key management module 1008 may include the key identifier, but in other examples, the entire data object may be transferred for decryption by key management module 1008.

In some instances, supplemental data is generated for each data object as it is encrypted that comprises at least the key identifier for the key used in encrypting the object. Accordingly, when it is necessary to decrypt the data object, the supplemental data may be stripped to determine the key identifier. Once stripped, the key identifier may be compared with the data structure in key management module 1008 to determine the appropriate encryption key for decrypting the data object.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of managing encryption keys in an application container environment, the method comprising:
in one or more processing systems, identifying a plurality of data objects to encrypt for a plurality of application containers;
encrypting the plurality of data objects via a plurality of encryption keys;
generating supplemental data for each data object in the plurality of data objects, wherein the supplemental data for each data object in the plurality of data objects comprises a key identifier corresponding to an encryption key of the plurality of encryption keys used to encrypt each data object in the plurality of data objects;
associating the supplemental data for each data object with the encrypted version of each data object in the plurality of data objects; and
organizing key identifiers from the plurality of data objects into a data structure with the plurality of encryption keys.

2. The method of claim 1 wherein the method further comprises:
identifying a data object in the plurality of data objects to decrypt;
identifying a key identifier in supplemental data associated with the data object; and
decrypting the data object using an identified encryption key based on the key identifier and the data structure.

3. The method of claim 2 wherein identifying the data object in the plurality of data objects to decrypt comprises identifying, in a security layer of an application container, the data object in the plurality of data objects to decrypt.

4. The method of claim 1 wherein the plurality of encryption keys comprises a plurality of expiring encryption keys configured to encrypt data objects for a predefined period of time.

5. The method of claim 1 wherein associating the supplemental data for each data object with the encrypted version of each data object in the plurality of data objects comprises inserting the supplemental data for each data object within the encrypted version of each data object in the plurality of data objects.

6. The method of claim 1 wherein encrypting the plurality of data objects via the plurality of encryption keys comprises encrypting, in security layers for the plurality of application containers, the plurality of data objects via the plurality of encryption keys.

7. The method of claim 1 wherein encrypting the plurality of data objects via the plurality of encryption keys comprises encrypting, in at least one encryption system external to the plurality of application containers, the plurality of data objects via the plurality of encryption keys.

8. The method of claim 7 wherein the at least one encryption system external to the application containers comprises a key management service, and wherein organizing the key identifiers from the plurality of data objects into the data structure with the plurality of encryption keys comprises organizing, in the key management service, the key identifiers from the plurality of data objects into the data structure with the plurality of encryption keys.

9. A computer apparatus to manage encryption keys for a plurality of application containers, the computer apparatus comprising:
processing instructions that direct a computing system, when executed by the computing system, to:
identify a plurality of data objects to encrypt for the plurality of application containers;
encrypt the plurality of data objects via a plurality of encryption keys;
generate supplemental data for each data object in the plurality of data objects, wherein the supplemental data for each data object in the plurality of data objects comprises a key identifier corresponding to an encryption key of the plurality of encryption keys used to encrypt each data object in the plurality of data objects;
associate the supplemental data for each data object with the encrypted version of each data object in the plurality of data objects; and
organize key identifiers from the plurality of data objects in a data structure with the plurality of encryption keys; and
one or more non-transitory computer readable media that store the processing instructions.

10. The computer apparatus of claim 9 wherein the processing instructions further direct the computing system to:
identify a data object in the plurality of data objects to decrypt;
identify a key identifier in supplemental data associated with the data object; and
decrypt the data object using an identified encryption key based on the key identifier and the data structure.

11. The computer apparatus of claim 10 wherein the processing instructions to identify the data object in the plurality of data objects to decrypt direct the computing system to identify, in a security layer of an application container, the data object in the plurality of data objects to decrypt.

12. The computer apparatus of claim 9 wherein the plurality of encryption keys comprises a plurality of expiring encryption keys configured to encrypt data objects for a predefined period of time.

13. The computer apparatus of claim 9 wherein the processing instructions to associate the supplemental data for each data object with the encrypted version of each data object in the plurality of data objects direct the computing system to insert the supplemental data for each data object within the encrypted version of each data object in the plurality of data objects.

14. The computer apparatus of claim 9 wherein the processing instructions to encrypt the plurality of data objects via the plurality of encryption keys direct the computing system to encrypt, in security layers for the plurality of application containers, the plurality of data objects via the plurality of encryption keys.

15. The computer apparatus of claim 9 wherein the processing instructions to encrypt the plurality of data objects via the plurality of encryption keys direct the computing system to encrypt, in at least one encryption system external to the plurality of application containers, the plurality of data objects via the plurality of encryption keys.

16. The computer apparatus of claim 15 wherein the at least one encryption system external to the application containers comprises a key management service, and wherein the processing instructions to organize the key identifiers from the plurality of data objects into the data structure with the plurality of encryption keys direct the computing system to organize, in the key management service, the key identifiers from the plurality of data objects into the data structure with the plurality of encryption keys.

17. A computer apparatus to manage encryption keys in an application container environment, the computer apparatus comprising:
processing instructions that direct a computing system, when executed by the computing system, to:
identify a data object in a first application container for encryption;
generate an encrypted version of the data object via an encryption key;
associate a key identifier with the encrypted version of the data object, the key identifier corresponding to the encryption key;
store the key identifier and the encryption key within a data structure;
identify the encrypted version of the data object in a second application container for decryption;
identify the encryption key for decryption based on the key identifier associated with the encrypted version of the data object and the data structure;
decrypt the encrypted version of the data object via the encryption key; and
one or more non-transitory computer readable media that store the processing instructions.

18. The computer apparatus of claim 17 wherein the processing instructions to associate the key identifier with the encrypted version of the data object direct the computing system to insert the key identifier in the encrypted version of the data object.

19. The computer apparatus of claim 17 wherein the processing instructions further direct the computing system to, in response to associating the key identifier with the encrypted version of the data object, store the data object within a storage system, and wherein the processing instructions to identify the data object in the second application container for decryption direct the computing system to receive the data object in the second application container from the storage system.

20. The computer apparatus of claim 17 wherein the first application container and the second application container each comprise at least one application and a security layer, the security layer configured to act as a data intermediary between the at least one application and at least one process or system external to the first or second application container.
